(19) United States
(12) Patent Application Publication
(10) Pub. No.: US 2018/0231459 A1
(43) Pub. Date: Aug. 16, 2018

(54) LAB-ON-CHIP NEAR-INFRARED SPECTROMETER FOR LABEL-FREE MOLECULAR ANALYSIS OF A SAMPLE

(71) Applicant: B. G. NEGEV TECHNOLOGIES AND APPLICATIONS LTD. AT BEN-GURION UNIVERSITY, Beer Sheva (IL)

(72) Inventor: Alina KARABCHEVSKY, Haifa (IL)

(21) Appl. No.: 15/898,042

(22) Filed: Feb. 15, 2018

Related U.S. Application Data
(60) Provisional application No. 62/459,630, filed on Feb. 16, 2017.

(51) Int. Cl. G01N 21/359; B01L 9/00; G01J 3/42; G01J 3/02; G01J 3/453; G01N 21/31

(52) U.S. Cl. CPC G01N 21/359; B01L 9/527; G01J 3/42; G01J 3/0272; G01J 3/0267; G01J 3/453; G01N 21/314; G01J 3/0224

(57) ABSTRACT

The present application describes a NIR spectrometer for label-free, rapid, portable and high-precision molecular composition analysis of a sample. The NIR spectrometer is integrated in a lab-on-chip and comprises a broadband NIR source configured to generate NIR light pulses; collimating and focusing objectives; a PDMS chamber mounted on a silicate glass support and designed to be filled with the sample and to receive an NIR light beam from a channel waveguide; the cannel waveguide built in a silicate glass support and configured to transmit the NIR light beam through the sample; an optical spectrum analyser configured to receive the NIR light beam, partially absorbed by the sample, and to measure an output signal intensity of the light beam versus a wavelength of said light beam; optical fibres connecting the components of the NIR spectrometer; and a computing unit.

### RELATED APPLICATION

This application claims the benefit of U.S. Provisional Application Ser. No. 62/459,630, filed Feb. 16, 2017, the entire contents of which are hereby incorporated by reference.

### TECHNICAL FIELD

The present application relates to the fields of near-infrared spectroscopy and molecular analysis. In particular, the present application relates to a lab-on-chip near-infrared spectrometer for label-free molecular analysis of a sample.

### BACKGROUND

Optical spectroscopy in the near-infrared (NIR) or visible spectra provides a simple analytical method for analysing characteristics of target materials in a wide range of applications. Until recently, designers looking to apply optical spectroscopy to mass market have been hobbled by limitations of traditional spectrophotometers with their large size, complexity, and cost that limited many of those applications to research laboratories and enterprise operations, placing the technology out of reach of emerging opportunities, particularly in a mobile sector. Requirements for spectrum analysis in many of these emerging applications are substantially more modest than those facing a research scientist.

Today, developers are looking to implement the NIR optical spectroscopy in a wide class of mass-market applications in home, business, and industrial segments. Unlike traditional applications, these rely on readily accessible, real-time and low-cost handheld spectrum analysers for various routine applications such as verifying currency, confirming purity of water, food and beverages, and checking integrity of household structures. Indeed, the ability for users to easily characterise materials at home and work, rather than bring samples to expensive laboratories, opens broad opportunities for product developers.

Availability of miniaturised single-chip multi-spectral sensing devices having minimal size, low power, and ease of use, has now completely removed the barriers to implementation of simpler, lower cost spectrometer designs. Using these devices, many developers can now address emerging opportunities for mobile optical spectrometers. As a result, from its pioneering uses in chemistry and physics, the basic NIR optical spectroscopy has moved out of the lab, enabling a broad array of enterprise-level applications in biotechnology, pharmacology, medicine, and telecommunications.

Optical spectrum analysis is simple in concept. After illuminating a target with an appropriate light source, an absorption spectrometer captures the distinct wavelengths of light that remain after the source illumination passes through a target liquid solution. Because the target's materials effectively absorb a characteristic set of wavelengths, analysis of the transmitted light can reveal information about the target's chemical purity and molecular identity.

Every molecule has a unique infrared absorption spectrum that stems from its molecular vibrations and rotations. The absorption is strongest at the fundamental vibration frequencies, but these are mostly inaccessible with the present IR spectro-photometers. However, as the molecules can be represented as inharmonic oscillators, overtone transitions occur, that are weaker in nature but can be detected in the near-infrared region. For example, the first overtones of C—H stretching vibrations can be accessed in the wavelength range of 1530-1820 nm.

In general, vibrational overtone spectroscopy of molecules is a powerful tool for drawing information on molecular structure and dynamics. It relies on absorption of the NIR radiation by molecular vibrations. The most wide-spread method of vibration spectroscopy of molecules relies on the operations in a mid-infra-red (Mid-IR) spectral range. Bernhardt et al. (2010) in “Cavity-enhanced dual-comb spectroscopy”, Nature Photonics 4, 55-57, showed the recorded spectra of ammonia 1.0 μm overtone bands in the Mid-IR spectral range, comprising 1,500 spectral elements and spanning 20 nm, with a resolution of 4.5 GHz and a noise equivalent absorption at 1 second averaging of 1×10⁻¹⁰ cm⁻¹Hz^{-1/2}, within a period of just 18 μs, thus opening a route to time-resolved spectroscopy of rapidly evolving single events.

However, there are several disadvantages of the Mid-IR technique, namely large size, complexity and high cost of the spectrophotometer, and large quantities of sample solutions required in order to extract high precision data on spectral positions of vibrational modes. There is a long-time need for a small NIR molecular spectrometer for label-free molecular analysis of low-volume samples in point-of-care applications.

### SUMMARY

The present application describes embodiments of a NIR spectrometer for label-free molecular analysis of a sample, said NIR spectrometer is integrated in a lab-on-chip and comprises:
a) a broadband NIR source configured to generate NIR light pulses;
b) a single-mode (SM) optical fibre optically connecting the broadband NIR source with a collimating objective and designed to transmit said NIR light pulses from said NIR source to said collimating objective;
c) the collimating objective configured to collimate the NIR light pulses received from the NIR source into a narrow collimated NIR light beam, and directing said narrow collimated NIR light beam to a focusing objective;
d) the focusing objective configured to receive the narrow collimated NIR light beam from the collimating objective, to align on-axis the NIR beam and to focus said beam onto a polarisation maintaining optical fibre;
e) the polarisation maintaining (PM) optical fibre optically coupled into a channel waveguide of a polydimethylsiloxane (PDMS) chamber, optically connecting the focusing objective with the channel waveguide, and configured to transmit the focused NIR light beam from the focusing objective into the channel waveguide;
f) the PDMS chamber mounted on the silicate glass support and designed to be filled with the sample and to receive the NIR light beam from the channel waveguide;
g) the cannel waveguide of the PDMS chamber, built in a silicate glass support and configured to transmit the NIR light beam to and from the PDMS chamber;
h) a multi-mode (MM) optical fibre optically coupled into the channel waveguide of the

PDMS chamber, optically connecting the channel waveguide with an optical spectrum analyser and configured to transmit the NIR light beam into the optical spectrum analyser;
i) the optical spectrum analyser configured to receive the NIR light beam, partially absorbed by the sample and transmitted from the PDMS chamber, to measure an output signal intensity of the NIR light beam versus a wavelength of said NIR light beam, and to transfer the obtained signal intensity data to a computing unit; and
j) the computing unit configured to receive the signal intensity data from the optical spectrum analyser, to perform calculations relating to mathematical analysis of the data and to display said data in a readable format or to plot said data in a form of a transmittance or absorbance spectrum of the sample.

In a further embodiment, the broadband NIR source is a high-power fibre-continuum laser configured to operate at the central wavelength of 1060 nm with spectral bandwidth ranging from 450 nm to 1750 nm and to generate optical pulses with a duration less than 10 ps.

In a specific embodiment, the PM optical fibre optically connecting the focusing objective with the channel waveguide may be an 8-μϕ polarisation-maintaining optical fibre. In another specific embodiment, the MM optical fibre optically connecting the channel waveguide with the optical spectrum analyser may be a 62-μϕ or 200-μϕ multi-mode optical fibre. In a particular embodiment, the SM, PM and MM optical fibres each comprises an optical fibre interface allowing the NIR light beam to enter and exit the optical fibre.

In yet further embodiment, the optical spectrum analyser is a wavelength-selective optical power meter that measures signal power versus wavelength, and is tunable over a specified wavelength range. The optical spectrum analyser may be configured to analyse the spectrum over the range from 600 nm to 1700 nm.

In another embodiment, the lab-on-chip further comprises on-chip microfluidic channels or one or more functional microfluidic device. These functional microfluidic device may be adapted to generate micro-droplets of the sample or may constitute a micro-reactor allowing one or more reactions to occur within the microfluidic device.

### BRIEF DESCRIPTION OF THE DRAWINGS

The patent or application file contains at least one drawing executed in color. Copies of this patent or patent application publication with color drawings will be provided by the Office upon request and payment of the necessary fee.

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1a schematically shows a NIR spectrometer of the embodiments for label-free molecular analysis of a sample.

FIG. 1b shows an artist's image of the NIR spectrometer of the embodiments.

FIG. 1c shows a photo of the PDMS chamber, which is mounted on the silica glass support and receiving the NIR light beam from the channel waveguide built in the silicate glass support.

FIG. 2a schematically illustrates the Beer-Lambert Law in the ballistic regime when incident light Iᵢₙ becomes weaker by e^{-αL} as it passes through the solution layer of the width L.

FIG. 2b schematically illustrates the Beer-Lambert Law in the diffusive regime when incident light Iᵢₙ becomes weaker by e^{-αL} as it passes through the solution layer of the width L.

FIG. 3a shows transmittance spectra of pure N-methylaniline (NMA) (red line), pure hexane (black line) and five different NMA samples diluted in hexane at different concentrations.

FIG. 3b shows transmittance spectra of the 66.7% NMA solution in hexane recorded with the NIR spectrometer of the embodiments. The first spectrum (blue line) was recorded in 30 min after the sample was introduced in the PDMS chamber. After that, the spectra were recorded at time intervals of about 1 min. The red curve shows the spectrum recoded in 35 minutes and clearly indicates the decrease in transmittance of the tested solution by 18 dB.

FIG. 3c shows experimental transmittance modulation depth of the N—H bond stretching vibrational band plotted as a function of time.

FIG. 4a shows measured absorbance of pure NMA and the corresponding calculated K value.

FIG. 4b shows calculated transmittance spectrum of the pure NMA in the ballistic regime.

FIG. 4c schematically shows the refractive index profile n (x, y) for transverse electric polarization (TEP) of the waveguide calculated with COMSOL Multiphysics 4.3b software package, photon ballistic path length L, and photon elastic scattering mean-trajectory.

FIG. 4d schematically shows the ballistic (yellow arrows) and diffusive (red arrows) pathways of the NIR photons in the channel waveguide (the sample region is not shown for simplicity) with organic molecules adsorbed to the surface. The blue curve describes the electric field intensity spatial distribution of the fundamental mode in a guide |ε_{y}(x, y, z)|.

FIG. 5a schematically illustrates a multilayer structure of NMA formed on the surface of the channel waveguide in the 67% NMA solution in hexane. The dashed lines indicate tentative hydrogen bonding between aniline molecules.

FIG. 5b shows the contact angle measurements of the channel waveguide surface. The surface becomes modified due to adsorption of the NMA molecules onto it. The figure shows the water droplets having the contact angles ∠10°, ∠20° and ∠56° on the clean silica glass of the channel guide. As a result of the NMA molecules interaction with the silica surface, the contact angle significantly increases.

FIG. 6 shows the transmittance spectra of the 67% NMA solution in hexane recorded with the NIR spectrometer of the embodiments at two different path lengths: L=1.5 mm and L=3.

### DETAILED DESCRIPTION

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising x and z” should not be limited to devices consisting only of components x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached to”, “connected to”, “coupled with”, “contacting”, etc., another element, it can be directly on, attached to, connected to, coupled with or contacting the other element or intervening elements may also be present. In contrast, when an element is referred to as being, for example, “directly on”, “directly attached to”, “directly connected to”, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

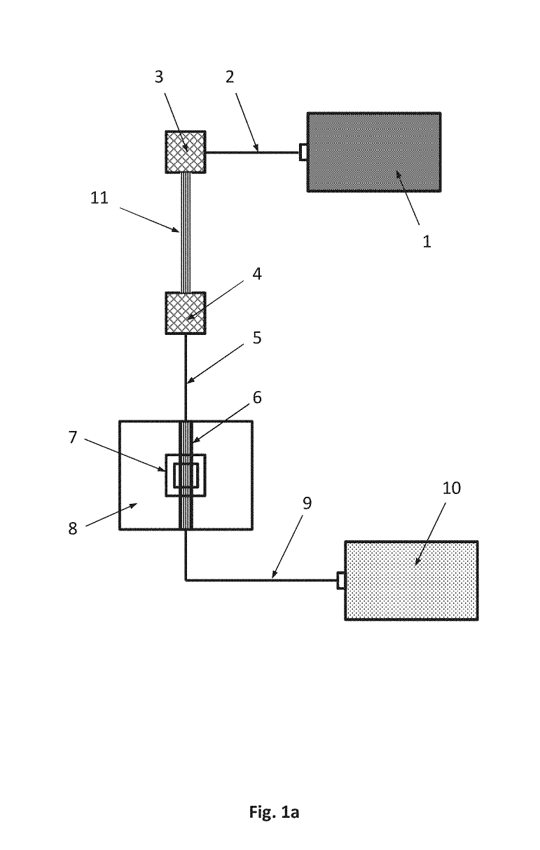

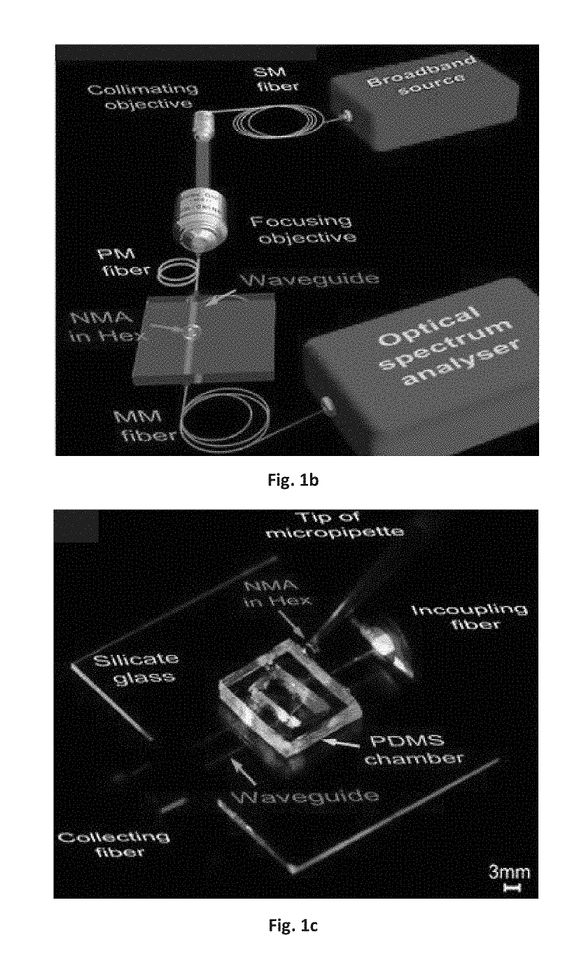

Reference is now made to FIG. 1a schematically showing a spectrometer of an embodiment of the present application, operated in the near-infrared (NIR) spectral region, integrated in a lab-on-chip, and comprising its major components defined as follows:
a) a broadband NIR source (1), which is configured to generate NIR light pulses;
b) a single-mode (SM) optical fibre (2) optically connecting the broadband NIR source (1) with a collimating objective (3) and designed to transmit said NIR light pulses from said NIR source (1) to said collimating objective (3);
c) the collimating objective (3) configured to collimate the NIR light pulses received from the NIR source (1) into a narrow collimated NIR light beam (11), and directing said narrow collimated NIR light beam (11) to a focusing objective (4);
d) the focusing objective (4) configured to receive the narrow collimated NIR light beam (11) from the collimating objective (3), to align on-axis the NIR beam (11) and to focus said beam (11) onto a polarisation maintaining optical fibre (5);
e) the polarisation maintaining (PM) optical fibre (5) optically coupled into a channel waveguide (6) of a polydimethylsiloxane (PDMS) chamber (7), optically connecting the focusing objective (4) with the channel waveguide (6), and configured to transmit the focused NIR light beam from the focusing objective (4) into the channel waveguide (6);
f) the PDMS chamber (7) mounted on the silicate glass support (8) and designed to be filled with a sample and to receive the NIR light beam from the channel waveguide (6);
g) the cannel waveguide (6) of the PDMS chamber (7), built in a silicate glass support (8) and configured to transmit the NIR light beam to and from the PDMS chamber (7);
h) a multi-mode (MM) optical fibre (9) optically coupled into the channel waveguide (6) of the PDMS chamber (7), optically connecting the channel waveguide (6) with an optical spectrum analyser (10) and configured to transmit the NIR light beam partially absorbed by the sample into the optical spectrum analyser (10);
i) the optical spectrum analyser (10) configured to receive the NIR light beam partially absorbed by the sample and transmitted from the PDMS chamber (7), and to measure an output signal intensity of this NIR light beam as a function of a wavelength of said NIR light beam, and to transfer the obtained signal intensity data to a computing unit; and
j) the computing unit configured to receive the signal intensity data from the optical spectrum analyser (10), to perform calculations relating to mathematical analysis of the data and to display said data in a readable format or to plot said data in a form of a transmittance or absorbance spectrum of the sample.

Further, FIG. 1b shows an artist's image of the aforesaid NIR spectrometer of the embodiments, and FIG. 1c shows a photo of the PDMS chamber (7) mounted on the silica glass support (8) and receiving the NIR light beam from the channel waveguide (6) built in the silicate glass support (8). As mentioned above, the channel waveguide (6) is transmitting the NIR light beam to and from the PDMS chamber (7). As an example, shown in FIG. 1c, solution of a sample contacting NMA in hexane is dropped with a micropipette directly into the PDMS chamber (7) for measurements. In the photo, there are actually two channel waveguides shown, which are illuminated by coherent red and green light beams for demonstration of multi-array analysis of the sample. “Incoupling” fibre is the PM fibre (5) optically coupled into the channel waveguide (6), connecting the focusing objective (4) with the channel waveguide (6), and further transmitting the focused NIR light beam from the focusing objective (4) to the channel waveguide (6). “Collecting” fibre is actually the MM fibre (9), which is optically coupled into the channel waveguide (6), thereby connecting the channel waveguide (6) with an optical spectrum analyser (10), and transmitting the partially absorbed NIR light beam into the optical spectrum analyser (10).

The collimating objective (3) is a device that narrows a beam of particles or waves. To narrow means either to cause the directions of motion/propagation to become more aligned in a specific direction (i.e., make collimated light or parallel rays), or to cause the spatial cross section of the light beam to become smaller. Collimated light is light whose rays are parallel, and hence, will spread minimally as it propagates. A perfectly collimated beam, with no divergence, would not disperse with distance.

In a specific embodiment, there are no physical optical elements between the collimating objective (3) and the focusing objective (4). The narrow collimated NIR light beam (11) is directed by the collimating objective (3) onto the focusing objective (4) and passes into the focusing objective through space.

The exemplary PM optical fibre (5) optically connecting the focusing objective (4) with the channel waveguide (6) is an 8-μϕ polarisation-maintaining optical fibre. It transmits the focused NIR light beam from the focusing objective (4) into the channel waveguide (6) as described above.

The exemplary MM optical fibre (9), which is optically connecting the channel waveguide (6) with an optical spectrum analyser (10), is a 62-μϕ or 200-μϕ multi-mode optical fibre. The MM optical fibre (9) transmits the NIR light beam partially absorbed by the sample to an optical frontend of the optical spectrum analyser (10). Each optical fibre has its own optical fibre interface allowing the light beam to enter and exit the optical fibres.

The optical spectrum analyser (10) is a wavelength-selective optical power meter that measures signal power versus wavelength (or frequency), tunable over a specified wavelength range. In general, optical spectrum analysers are very similar to wavelength meters in that they produce a spectrum of intensity versus wavelength, but each has a slightly different specialty. While wavelength meters pinpoint a wavelength of a laser to an extremely high accuracy, optical spectrum analysers measure both wavelength and intensity of a laser at a high accuracy, often across a much wider dynamic range of wavelengths. This makes optical spectrum analysers very useful for analysing transmitted signals, in particular, for discriminating a desired signal from unwanted noise, known as the optical signal-to-noise ratio.

Optical spectrum analysers typically use either direct spectral measurement or Fast-Fourier Transform (FFT)-based measurement. An optical spectrum analyser that incorporates the FFT-based measurement is often called a multi-wavelength meter, which can achieve results with a strong emphasis on high-performance wavelength certainty at the expense of uncertainties in power measurement, such as peak power and noise floor in the presence of multiple channels, or polarization-dependent power.

A typical direct-measurement optical spectrum analyser has a wavelength axis calibrated to measure absolute wavelength to about ±0.01 nm. A multi-wavelength meter (an FFT-based optical spectrum analyser) typically measures relative power. So the user must decide which axis is more important, the intensity axis or the wavelength axis. Bristol Instruments (Victor, N.Y.), specializes in such multi-wavelength meters, which incorporate a scanning Michelson interferometer with the wavelength axis calibrated to as low as ±0.0001 nm. The Michelson interferometer-based optical spectrum analysers are limited to a dynamic range of about 30 or 40 dB. Examples are Bristol Instruments' 621B-MIR and Agilent' s 86120B multi-wavelength meters.

The optical spectrum analyser (10) used in the prototype spectrometer of the present embodiments is of Yokogawa's series (Yokogawa Corporation, Newnan, Ga.). It is Yokogawa AQ6370 providing an expanded-wavelength-range analyser having high-performance and covering wavelengths from 600 to 1700 nm.

The computing unit is capable of collecting, analysing and displaying the spectral NIR data received from the optical spectrum analyser (10) in a readable format, controlling the NIR spectroscope, visually displaying the NIR spectrum of the sample, calculating molecular composition of the sample and concentration of a tested analyte in the sample, obtained from the NIR data using a concentration algorithm, and further transmitting the obtained calculation results, for example, to a medical diagnostic cloud or to a process control system for improving and optimising the process via real-time close loops or via massive data collection and big data analysis.

The NIR spectrometer of the embodiments is integrated in a lab-on-chip and used for label-free, rapid, portable and high-precision molecular analysis of a sample. Further elements of the chip may comprise, for example, on-chip microfluidic channels. The size of these microfluidic channels is less than 500 μm. The lab-on-chip may further comprise one or more functional microfluidic device, such as a microfluidic device which is adapted to generate micro-droplets of the sample, or a micro-reactor for allowing one or more reactions to occur within the microfluidic device.

The NIR spectrometer is designed to measure the resonant NIR absorption spectra of organic molecules. The prototype NIR spectrometer of the embodiments was used to perform the transmission spectroscopy measurements of samples containing aromatic amines, such as aniline and N-methylaniline (NMA). Absorption efficiency of the sample solutions introduced into the PDMS chamber sitting on the channel waveguide was found to increase by a factor of about 300 compared to the theoretical values calculated for ballistic NIR photons propagated in the channel waveguide. This dramatic enhancement may be explained by switching between ballistic and diffusive propagation regimes of the photons induced by resonant scattering of light on organic molecules. This requires further explanation.

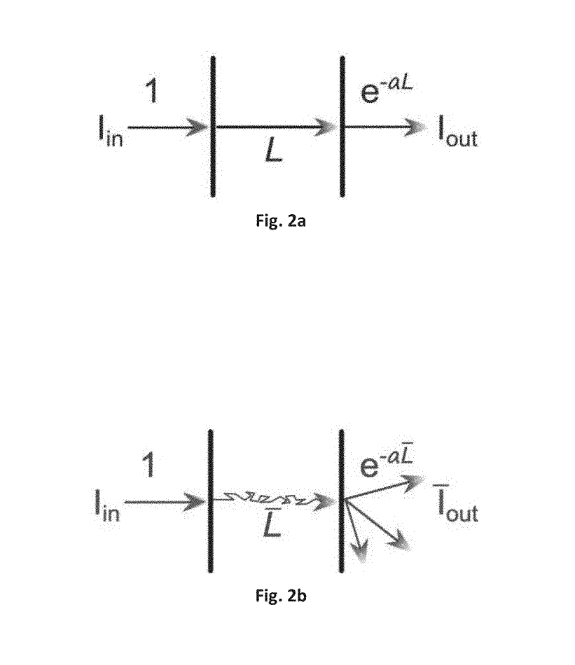

In general, light travelling in condensed media consists of three components: the ballistic, the diffusive and the snake photons. These differ in their paths through the medium, and consequently in their imaging properties. The unscattered or forward scattered photons travel without deviation from their initial path, and they are the first protons to emerge from the media, simply because they travelled the shortest distance through this medium (see FIG. 2a). These photons preserve the characteristics of the incident light, namely direction of propagation, polarization and are hence best suited for imaging.

The ballistic photons are defined as the light photons that travel through a scattering medium in a straight line. Also known as ballistic light. If laser pulses are sent through the scattering medium such as fog or body tissue, most of the photons are either randomly scattered or absorbed. However, across short distances, a few photons pass through the scattering medium in straight lines. These coherent photons are referred to as ballistic photons. Photons that are slightly scattered, retaining some degree of coherence, are referred to as snake photons.

The ballistic propagation of light is described by the Beer-Lambert law relating to the waveguide transmission T=10^{-A}=Iᵢₙ/Iₒᵤₜ=e^{-αL}, which is expressed in % values as % T=100×T. Absorbance is then A=log₁₀Iᵢₙ/Iₒᵤₜ=log₁₀ 100/% T. The latter allows easily calculating the absorbance value from the percentage transmittance data using the following formula: A=2−log₁₀ % T. According to the Beer-Lambert law, the incident light intensity becomes weaker by e^{-αL} as the light passes through the solution layer of the width L. In the ballistic regime, the time which a photon spends in solution is directly proportional to the travelled distance, which is L defined as a penetration length of light in the absorbing medium. The coefficient α=ϵc, where ϵ is the molar absorptivity and c is the concentration of a compound in the sample.

However, in reality, the ballistic photons are few in number. The diffuse component, which forms the bulk of the emergent light in a tested solution is made up of photons that have undergone random multiple scattering, and these emerge later than the ballistic photons because of their increased path lengths. Their polarization, direction of propagation and phase are completely randomised. In the diffusive regime, there is a square dependence (L²) between the time which a diffusive photon spends in solution and its travelled distance. FIG. 2b schematically illustrates the Beer-Lambert law in the diffusive regime when incident light becomes weaker by e^{-αL̅} as it passes through the solution layer of the width L̅. In other words, in the diffusive regime, L is replaced by an effective length L̅ which can be estimated as:

$$L = ϑ \frac{{L}^{2}}{D} , \qquad ( 1 )$$

where D is the diffusion coefficient, and ϑ is the ballistic speed of light in the tested solution. For most techniques of imaging, the diffusive photons are unwanted, because they create incoherent and diffusive background.

Thus, resonant elastic scattering of light may be visualised as a chain of coherent absorption and re-emission events. Photons are re-emitted in many random directions as the wave-vector is not conserved by the system. The resonant scattering results in the significant increase of the mean trajectory of photons travelling through the guide. Consequently, light spends longer time in the absorbing medium, so that the percentage of its absorbed energy strongly increases as compared to the ballistic propagation regime.

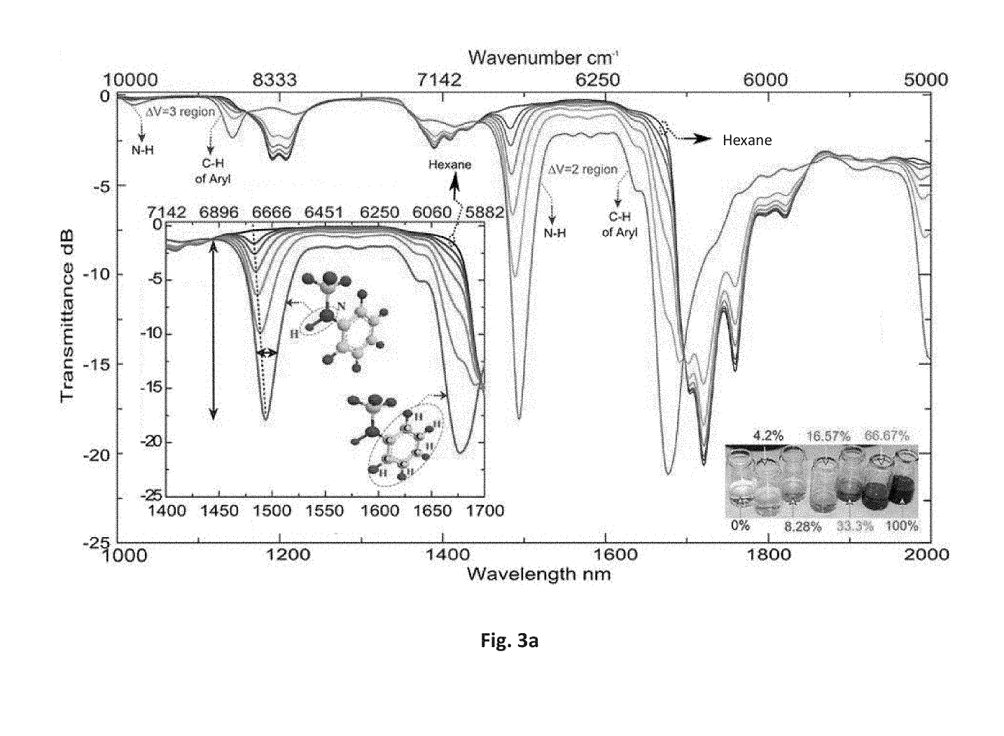

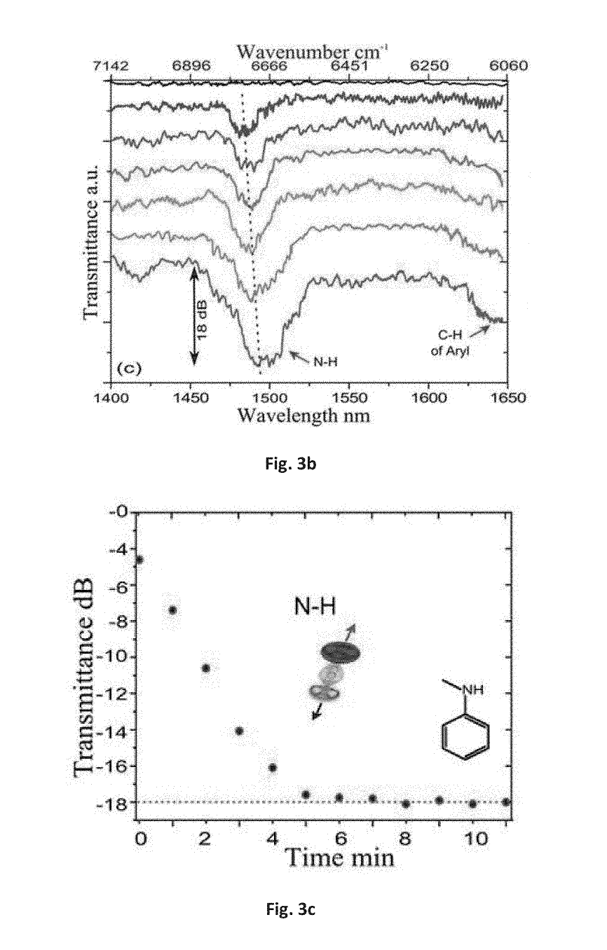

FIG. 3a shows transmittance spectra of pure N-methylaniline (NMA) (red line), pure hexane (black line) and five different NMA samples diluted in hexane at different concentrations (4.2%—blue line, 8.3%—violet line, 16.6%—magenta line, 33.3%—green line and 66.7%—cyan line). The spectra were recorded with Jasco V570 spectrophoto-meter at temperature of 21±2° C. and converted to decibel (dB) unit to express relative differences in signal strength. The channel waveguide was optimised for a single-mode regime around 1.5 μm and supported the overtone electronic states only in the first overtone region (ΔV=2) corresponding to the transition from the ground vibrational state to the second vibrational state.

The inset shows the absorption bands of NMA due to the (N—H)-bond stretching vibration around 1.5 μm and the aryl (C—H) overtone vibrational band around 1.65 μm in the ΔV=2 region. Shift in location of the N—H band is attributed to the increased concentration shown by the dashed line. Double-side arrows indicate a change in the signal strength and in the band width. The cuvette path length was 5 mm and the measurement was performed at normal incidence with air as reference. The photos of pure NMA and the diluted samples having different concentrations and prepared for measurements are shown in the inset (the coloured numbers indicate the sample concentrations as mentioned above and correspond to the coloured lines of the spectra).

Thus, integrated optics or thin-film guided-wave optics may benefit from such miniaturization due to manipulation of the optical waves guided in a thin film deposited on a low-refractive-index substrate. Light can be guided in a doped substrate if the dopant induces an increase of its refractive index. K⁺ ions diffused in the silicate glass have been used herein to form the guiding layer with a high refractive index. The optical mode in such structures can also be confined laterally due to the dopant concentration variation in the plane of the structure (see Eq. 1 below). Therefore, such structure is capable of preventing lateral diffraction of NIR to the edges of the guided region.

In diffusion-based waveguides, lateral confinement is governed by the width of the dopant distribution as shown in Eq. 1 below. Light guided within a thin film, which is illuminated by a single-mode fibre or a waveguide makes it possible to conduct the transmittance spectroscopy studies of the media surrounding the waveguide, due to the evanescent tails of the propagating light mode.

FIG. 3b shows transmittance spectra of the 66.7% NMA solution in hexane recorded with the NIR spectrometer of the embodiments. The first spectrum (blue line) was recorded in 30 min after the sample was introduced in the PDMS chamber. After that, the spectra were recorded at time intervals of about 1 min, and the decrease of transmittance was clearly observed. The red line corresponds to the spectrum recoded in 35 minutes and clearly indicates the decrease in transmittance of the tested solution by 18 dB. The spectrum curves are shifted along the transmittance Y-axis for the sake of clarity. The N—H bond stretching and aryl C—H bond overtone vibrational bands are indicated by green arrows. Reproducibility of the transmittance spectra was checked in a series of measurements. The experimental accuracy was kept within a 2% margin at the resonance wavelengths and at less than 1% for the background transmittance.

The effective concentration of NMA in the vicinity of the channel waveguide surface was surprisingly found to be increasing with time and eventually achieved the maximum loss of about −18 dB (see FIG. 3b), which corresponds to the loss measured for pure NMA. The NIR measurements of the NMA samples having different concentrations in hexane support the initial idea that the presence of hexane in the diluted samples shifts the N—H peak toward shorter wavelengths. The NIR data of the 67% NMA sample in hexane recorded on the channel waveguide clearly demonstrates that the centre of the N—H peak shifts from 14.75 μm to 14.9 μm in 35 minutes, thereby indicating that the concentration of NMA within the penetration depth of evanescent NIR field increases with time. This signal then remains steady, thereby evidencing that a dense organic layer was formed near the surface and hexane molecules were pushed beyond the evanescent field region. FIG. 3c shows experimental transmittance modulation depth of the N—H bond stretching vibrational band plotted as a function of time and supporting this conclusion. Complementary surface analytical techniques, such as ellipsometry and contact-angle measurements were used to characterise the formed organic layer (see the experimental section).

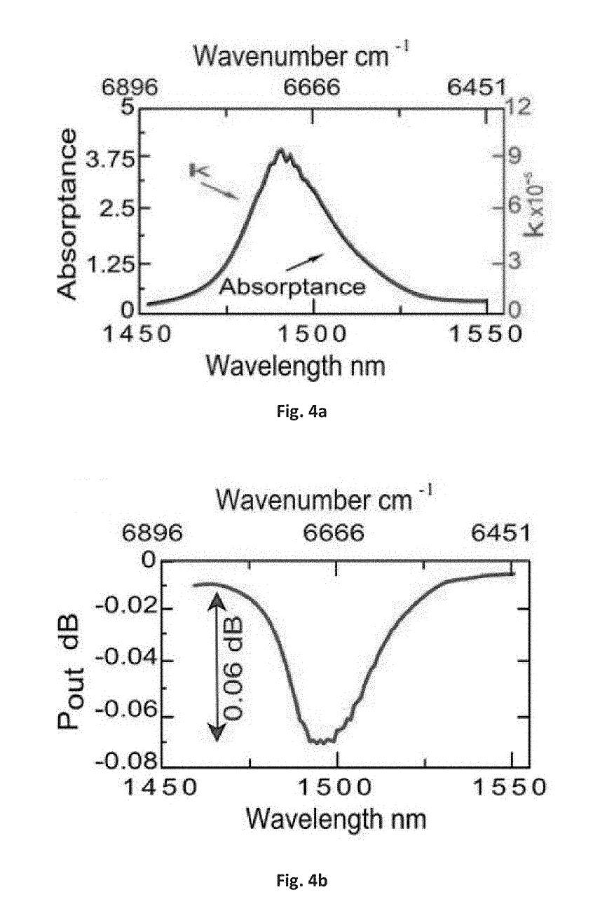

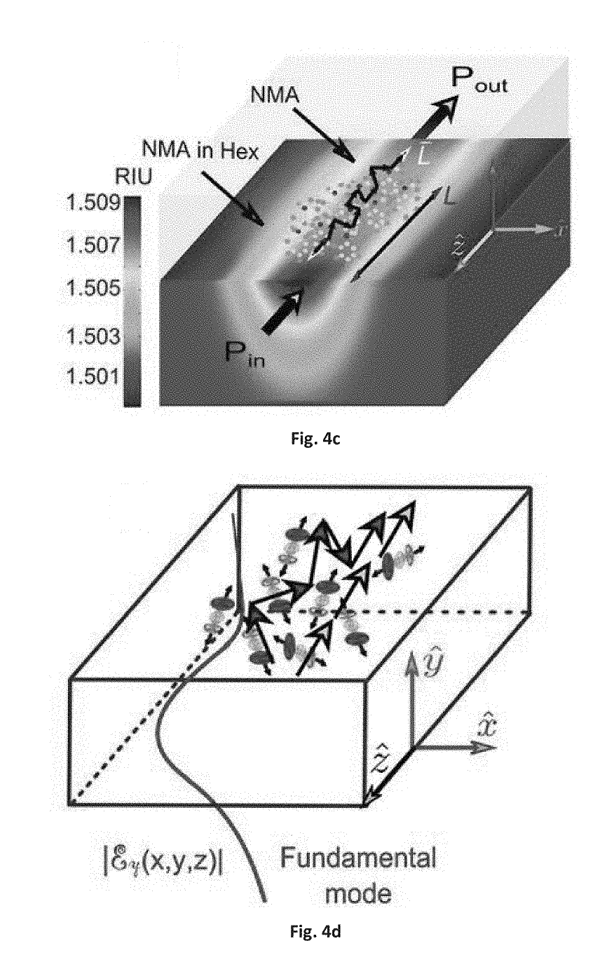

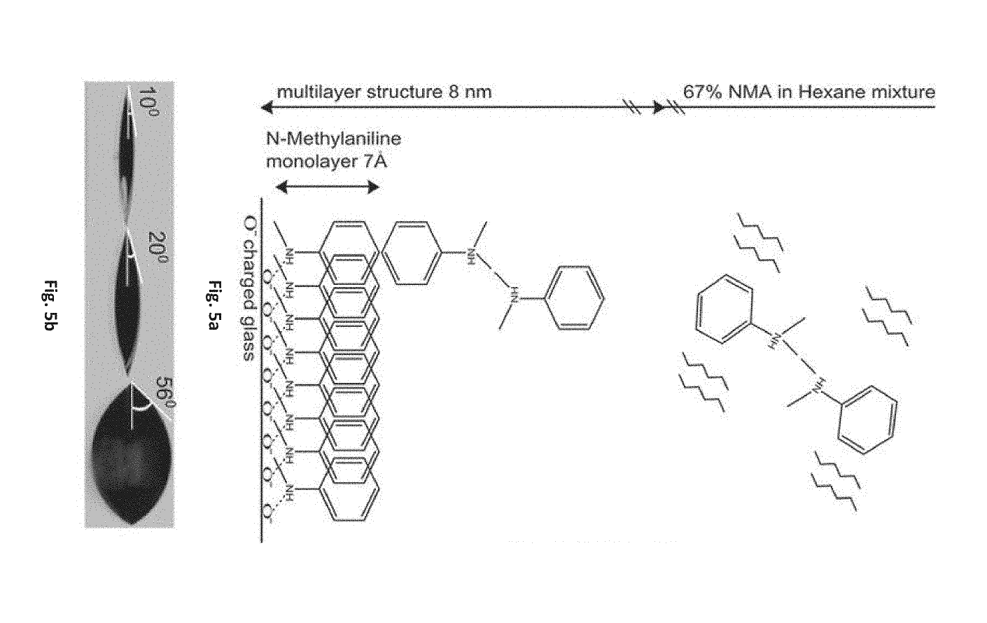

Reference is now made to FIGS. 4a-4d illustrating the transition from ballistic to diffusive propagation in the channel waveguide due to diffusion by NMA molecules. FIG. 4a shows measured absorbance of pure NMA and the corresponding calculated κ value, while FIG. 4b shows the calculated transmittance spectrum of pure NMA in the ballistic regime. FIG. 4c schematically shows the refractive index profile n(x, y) for transverse-electric (TE) polarization of the waveguide calculated according to Eq. 1 with COMSOL Multiphysics 4.3b software package, photon ballistic path length L, and photon elastic scattering mean-trajectory. FIG. 4d schematically shows the ballistic (yellow arrows) and diffusive (red arrows) pathways of the NIR photons in the channel waveguide (the sample region is not shown for simplicity) with organic molecules adsorbed to the surface. The blue curve describes the electric field intensity spatial distribution of the fundamental mode in a guide |ε_{y}(x, y, z)|.

The magnitude of the observed effect should be emphasised. As mentioned above, the channel waveguide was designed for the single-mode operation and high sensitivity at a wavelength of 1.5 μm. This was done by using a finite element method and employing an approximate diffusion profile of potassium ions in glass with the maximum core index of 1.5105, in accordance with Eq. 2 below and as described in the publication by Tervonen and Honkanen (1996), “Feasibility of potassium exchanged waveguides in BK7 glass for telecommunication devices”, Appl. Opt. 35, 6435-6437:

$$n ( x , y ) = {n}_{s} + Δ n erfc ( \frac{y}{dy} ) {e}^{- {x}^{2} / {dx}^{2}} \qquad ( 2 )$$

In the above equation, nₛ is a substrate refractive index (which is 1.5013 for the silicate glass support at 1.496 μm), coordinate y is a distance from the surface, coordinate x is a lateral distance from the waveguide symmetry axis, Δn is the maximum increase of the refractive index due to the dopant (which is 0.0092 for transverse-magnetic (TM)- and 0.008 for transverse-electric (TE)-polarisation modes), er f c is a complementary error function, dx is a profile depth and dy is a profile half-width.

The resonant scattering leads to switching from the regime of ballistic to diffusive propagation of light, which is a phenomenon well known in many biological tissues, where photon propagation is quickly randomized due to the elastic scattering. That results in a background loss of optical transmittance and in a strong delay of the transmission of light around the resonance band.

In general, photons propagating through a waveguide in the diffusion regime are absorbed with higher probability than in the ballistic regime. This unusual tendency has recently been established in the experiments on exciton-polaritons propagating through crystal slabs by Zaitsev et al (2015), “Diffusive propagation of exciton-polaritons through thin crystal slabs”, Nature: Scientific Reports, 5, 11474. Opals, dielectric super-lattices, biological tissues are characterized by a diffusive propagation of light that leads to ‘slow light’ phenomenon. The absorption of the slow light is enhanced as compared to the absorption of the conventional ‘fast light’ for the simple reason that the slow light spends longer time in the absorbing medium. This has been evidenced experimentally and described theoretically in Zaitsev et al (2015) and in Shubina et al (2008), “Resonant light delay in GaN with ballistic and diffusive propagation”, Physical Review Letters, 100, pages 1-4. Thus, qualitatively, the longer time a photon spends in an absorbing medium the higher chances it has to be absorbed.

The absorption amplification due to the diffusive propagation of light through the channel waveguide of the present embodiments has been estimated. The extinction coefficient was calculated according the following equation:

$$κ ( λ ) = {log}_{e} ( {10}^{A ( λ )} ) \frac{λ}{4 π L} \qquad ( 3 )$$

As mentioned above and as shown in FIG. 4a, the measured absorbance spectrum of pure NMA was used to calculate the corresponding κ value. The absorption spectrum for this purpose was measured using a regular spectrophotometer with 10 mm path-length (L), and the κ value was calculated according to the above Eq. 3, and based on the Beer-Lambert law and on the measured absorbance (A) value.

The calculated transmittance spectrum of pure NMA in the ballistic regime shown in FIG. 4b was used to calculate the transmitted power P through the guide according to the following equation:

P=10 log(e^{-4πLκ/λ}) (4),

where L is the length of the contact region of the waveguide with the liquid sample. The transmitted power P through the channel waveguide was calculated to be −0.06 dB for the ballistic propagation of light, with L being approximately 3 mm.

In view of Eq. 4, the switch to the diffusive propagation therefore results in the replacement of L by L̅, which is much larger than L. In this case, the outgoing signal is reduced by a factor of L̅/L=P′ₒᵤₜ/Pₒᵤₜ, where P′ₒᵤₜ is a measured power, L̅ is the estimated mean trajectory of a photon in the diffusive medium, and Pₒᵤₜ is a transmitted power calculated using L as the trajectory length in the ballistic regime. Taking κ=9.4314×10⁻⁵, λ=1.496 μm, P′ₒᵤₜ=−18 dB, and Pₒᵤₜ=−0.06 dB, L was found to be 0.9 m. This significantly differs from the theoretical expectation for the ballistic propagation case by a factor of about 300. This surprisingly enormous difference can be explained by presence of two effects:
(1) the chemical adsorption of organic molecules to the surface of the waveguide channel, their reorganisation and the consequent formation of a dense structured layer; and
(2) the physical effect of the resonant scattering of NIR by disordered film of organic molecules.

In the performed theoretical studies and solving the Maxwell equation, the obtained increase in the effective thickness of the adsorbed molecular layer as a function of time was insufficient to explain such drastic increase of absorption in the ballistic model. It was therefore concluded that the resonant scattering of light by organic molecules located in a close vicinity to the channel waveguide is responsible for this observed effect. The scattering causes the photon propagation direction to change randomly as schematically shown in FIGS. 4c and 4d. The Maxwell solver is therefore no more suitable for description of light propagation in this regime. Instead, a diffusion equation for photons should be used (see Equation 4 in Shubina et al (2008) and the experimental section).

Shubina et al (2008) demonstrated an increased absorption and delayed propagation of light near the exciton resonance in GaN and in ZnO semiconductor crystals. In the present invention, the diffusive regime was established because of the adsorption of organic molecules onto the surface of the channel waveguide (see the experimental section). The formation of an 8-nm thick organic layer has been detected by ellipsometry. Reference is now made to FIG. 5a schematically showing a multilayer structure of NMA formed on the surface of the channel waveguide in the 67% NMA solution in hexane. The dashed lines indicate tentative hydrogen bonding between aniline molecules. As shown in FIG. 5a, attraction of the NMA molecules to the modified surface of the NIR spectrometer of the embodiments is driven by the surface tension between the non-polar hexane solvent and the polar channel waveguide surface.

The polar N—H bond in the NMA molecules can interact with the polar silica surface of the channel waveguide, and the non-polar benzene ring can interact with the non-polar hexane molecules, thereby effectively relieving the surface tension. Since the benzene rings in a non-polar solvent such as hexane tend to form self-assemblies, and the polar N—H bonds of the NMA molecules may tentatively form intramolecular hydrogen bonds, a multilayer structure shown in FIG. 5a may actually exist and form some kind of a lamellar liquid crystal. Further, contact angle measurements, which are shown in FIG. 5b, confirm that the channel waveguide surface was modified as a result of adsorption.

Thus, the organic molecules are capable of being adsorbed onto the surface of the channel waveguide and form a diffusive layer therein. This layer is responsible for the switch from ballistic to diffusive propagation of NIR light in the waveguide, thereby resulting in an enormously strong absorption of light. Compared to the previously demonstrated detection of N-methylaniline on a planar integrated optical component (see Karabchevsky et al, “Broadband near-infrared spectroscopy of organic molecules on compact photonic devices”, 5th International Topical Meeting on Nanophotonics and Metamaterials (NANOMETA '15), Seefield, Austria, 5-8 Jan. 2015), on a ring resonator (see Nitkowski et al, “Cavity-enhanced on-chip absorption spectroscopy using microring resonators”, Optics Express 16 (2008), pp. 11930-11936), and on microtapered fibre (see Karabchevsky et al (2015), as above), the NIR spectrometer of the embodiments achieved dramatically stronger absorption signal of N—H overtone at around 1.5 μm wavelength that allows cheap fabrication of the NIR spectrometer.

The “sample” introduced in the PDMS chamber of the NIR spectrometer may contain any molecules being identified or quantified or a mixture of these molecules. An example of such mixture may be a solution of an organic compound, such as NMA being tested, dissolved in a solvent, such as hexane, which is not tested. When more than one sample is used, the series of samples may contain different analyte molecules having different concentrations, for example, different chromatographic eluates or fractions leaving chromatographic systems over time.

In some embodiments, one of the samples may be used for calibration of the spectrometer. The “calibration sample” is a term used herein to define a sample where the material or materials to be identified are known materials of known concentration used for calibrating the NIR spectrometer's hardware or acquired data. The calibration sample is used when a calibration method such as the one described below is employed. Use of the calibration methods on the sample data collected with the spectrometer may not always be employed or even needed. These materials may also be referred to as “calibration materials” with no intention at distinguishing between these terms. The calibration sample may be considered to be a form of the actual sample as the testing method for the calibration sample is the same as for the actual sample using the same or similar spectrometer configuration. Similarly, conversion of the NIR light beam passing through the calibration sample to electronic signals and their processing in the optical spectrum analyser is the same as that of the NIR light beam passing through the actual sample.

It is very important to calibrate the NIR spectrometer of the embodiments before or during its operation. One of the calibration methods is known as an adaptive calibration, in which parameters are changed during the measurement process in order to minimize errors. An exemplary, but non-limiting, method that may be used is the well-known least mean squares filter method. In the present application, measurement errors may be estimated by measuring the difference between the expected results of the calibration sample(s) to the actual measured results of the calibration sample(s). The obtained differences are measured in the two dimensional space of: 1) wavelength, and 2) intensity.

Calibration parameters are defined as the calculated correction values that are obtained in order to modify the sample measurements to compensate for variations in the broadband NIR source performance. The method for calculation of the calibration parameters is adaptive since the measurements are used to modify the latest measurement results in an accumulated manner. The actual present results are added to prior results when using an adaptive algorithm. Such an algorithm, which is an exemplary non-limiting example, may be a moving average algorithm. The outputs of the calibration algorithm are calibration parameters in two dimensions, wavelength and intensity, as mentioned above.

The calibration parameters are utilised in the present invention in two ways:
1. Physical calibration. This is accomplished by modification of the physical settings of the broadband NIR laser. Changes in physical settings are calculated based on the above mentioned calibration parameters and known physical characteristics of the NIR laser, as determined by use of a formula or look-up table. This includes, for example, changing the laser diode's temperature in order to change its wavelength and changing the laser amplifier input current in order to change the laser output power.
2. Database calibration. Each of the measured results of the samples is modified according to the calibration parameters in both dimensions, wavelength and intensity. The modified measured results are then used to generate the NIR spectrum of the samples which is used for identification or quantitative analysis of analytes contained in the samples. Note that the calibration material need not be the same material as the analyte. As long as a known spectrum or series of spectra at different known concentrations for one or more known materials is available, adaptive calibration can be used.

To sum up, the NIR spectrometer of the present embodiments is a device for chemical and biological sensing, trace detection, and identification via unique analyte absorption spectral signatures. In a particular embodiment, the NIR spectrometer may be used as a fully-automatic, low-maintenance (without moving parts and consumables) molecular composition analyser for various medical, forensic, household, general consumer and industrial outdoor applications in a wide range of conditions, such as corrosive and explosive environments, high and low temperatures, high pressure and high humidity. The NIR spectrometer of the present embodiments may also be used for detection and identification of multiple analytes to be performed simultaneously using multiple channel waveguides built in the chip.

### EXAMPLES

### Sample Fabrication and Characterization

The waveguides were fabricated by photolithographic patterning of 250 nm thick hard mask on silicate glass. This results in the stripe openings of 6 μm width. Then, the glass was immersed in KNO₃ molten for 11 hours at 395° C. After ion-exchange the end facets of the glass were polished perpendicular to the waveguide resulting in formation of waveguides length of approximately 35 mm. Planar waveguides were characterised using Metricon prism coupler and found to be single mode operating at 1.5 μm and having three modes at 632.8 nm.

At 632.8 nm, an effective index of the fundamental (zero-order) mode was measured using transverse electric (TE) polarization to be 1.5191. It was also measured for the first order mode to be 1.5170, and for the second order mode to be 1.5157. Further, at 1.5 μm, the effective index of the fundamental (zero-order) mode was measured to be 1.5093.

In addition, channel ion-exchange waveguides were characterised by imaging the mode profile at the output of the waveguide on IR camera through the ×10 focusing length and found to be single mode at 1.5 μm and having three modes at 632.8 nm. Since the waveguides are optimised for telecommunication wavelengths, they exhibit surface scattering loss for visible light. This is why they can be visualised with green and red lasers as photographed in FIG. 1c.

The near field mode profiles were measured to estimate dimensions of the mode profile from the NIR spectrometer of the present embodiments, as compared to the mode of SM1550 fibre at the same distance from IEEE-1394 Digital Camera using ×10 objective and neutral density (ND20) filter to protect the camera from saturation. Mode profile of SM1550 fibre was about 9.3 μm. The width and depth of the mode profile of the NIR spectrometer of the embodiments were found as 5.2565 μm and 7.6826 μm respectively.

### Solvent Cleaning

Waveguides have been cleaned following standard solvent cleaning routine while increasing solvent polarity. Waveguides have been sonicated for 20 min ultrasonic bath, and then rinsed with isopropanol then with deionised water and blow dried with air gun.

### Surface Modification

Waveguides were cleaned from organic residues following solvent cleaning routine (see above) and negatively charged using Tepla 300 Plasma Asher machine at 1000 W with oxygen gas of 600 ml/min until the temperature of 145° C. was reached. The process took about 5-7 min. The power was then turned off to cool down the waveguides to 55° C. The procedure has been repeated once more in order to generate higher oxygen anions charge on the surface of the waveguides. This method yielded a very hydrophilic surface.

### Fabrication of the PDMS Chamber

To conduct the measurements of liquid samples on the channel waveguide, the polydimethylsiloxane (PDMS) chamber was fabricated. Sylgard 184 elastomer and curing agent were mixed together at a weight ratio of 10:1. Liquid PDMS was placed in vacuum conditions for 30 min, and then baked at 90° C. for 1 hr, resulting in a robust chamber. Bath-like shape has been formed using aluminium foil supported by a microscope glass. By inspecting the spectrum of the PDMS, it was confirmed that there is a non-absorbing material formed at the wavelengths of interest.

A demountable PDMS chamber of a 8-mm length was self-stick on top of the waveguides to contain the liquid. After 45 min of measurements, the PDMS chamber was detached from the waveguide and the droplet of about 3 mm in diameter remained on the surface.

### Optical Spectroscopy on a Waveguide

Transmittance spectra of a sample were recorded using the NIR spectrometer of the embodiments. The broadband NIR light source used in the prototype was a high-power fibre-continuum source Fianium SC-600-FC. The NIR light was generated by this source that was operated at the central wavelength of 1060 nm with spectral bandwidth spanning from 450 nm to beyond 1750 nm and generating optical pulses with a duration less than 10 ps.

The NIR light beam from Fianium SC-600-FC was collimated and focused onto the polarisation maintaining (PM) fibre using the Melles-Grot objective NA 0.65 at the magnification ×40 to control polarization in the system. The PM fibre was directly fibre-coupled into a channel waveguide (with coupling efficiency of 8 dB/nm), and the power transmitted through the channel waveguide was fibre-coupled using a graded index multimode (MM) fibre into an optical spectrum analyser (Yokogawa AQ6370). Spectral resolution was set to 0.5 nm. Acquisition time for the 300-nm spectral window was about 50 sec. No polarization dependency was confirmed.

The sample of pure NMA (refractive index n_{NMA}=1.57118) was diluted with hexane (refractive index of nₕₑₓₐₙₑ=1.37508) at the concentration ratio 2:3 resulting in the NMA solution in hexane with the refractive index of 1.46769. The refractive indices were measured using RA 510 refractometer operating at 589 nm at room temperature of 21±2° C.

To record the spectra of the sample, a 0.1-mL drop of the NMA sample in hexane was introduced into the PDMS chamber placed on the channel waveguide. The experiment on demonstration of the NMA spectral dynamics was carried out for 42 min.

Prior to the spectral measurements of aniline, the waveguides were cleaned and charged by oxygen anions in Tepla 300 Plasma Asher machine.

### Dependence of Absorption on Path Length

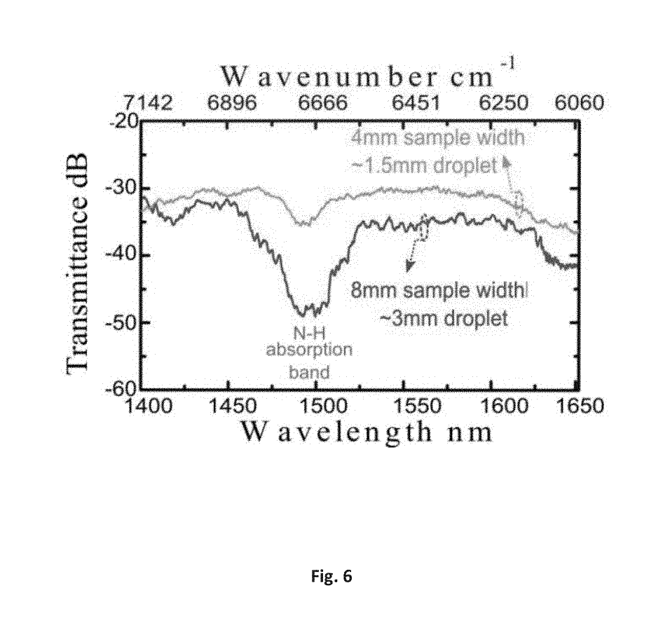

To assess the dependence of absorption on the path length of light, the sample solution of 67% NMA in hexane we introduced onto the surface of the channel waveguide at two different path lengths. The spectra at L=1.5 mm and at L=3 mm recorded from the channel waveguide are shown in FIG. 6. A superlinear dependence of the logarithm of transmittance on the length of the waveguide was clearly observed. This is a conclusive evidence for the diffusive propagation of light in the presence of strong scattering molecules such as NMA molecules.

### Conclusions on the Structured Multilayer

The NIR spectra shown in FIG. 3a recorded for the NMA samples having different concentration in hexane support the idea that in the presence of hexane the stretching N—H vibration peak is shifted towards shorter wavelengths. The NIR data recorded from the droplet of 67% NMA solution in hexane (see FIG. 3b) clearly shows that the centre of the N—H peak shifts in 35 min from about 1.475 μm to about 1.49 μm, thereby indicating that the NMA concentration in the vicinity of the channel waveguide surface increases from 4.2% to 100%. The optical transmittance then goes to plateau, thereby supporting the idea that the solvent has been excluded from the region near the surface of the channel waveguide, whilst a stable layer of the NMA molecules has been formed.

### Surface Tension Analysis

1 μL of water was introduced onto the surface of K⁺ exchanged silicate glass that had been treated with oxygen plasma. The same amount of water was introduced onto the surface of K⁺ exchanged silicate glass that had been treated with oxygen plasma and immersed in a 67% NMA solution in hexane for duration of 1 hour at room temperature. Contact angles were measured with a Kruss DSA100 (see FIG. 5b). In average, four drops of water were introduced in different areas of each sample. The mean values were reproducible within ±2° C. of the reported value.

Immersion of K⁺ exchanged silicate glass in the 67% NMA solution in hexane increased hydrophobicity of the silica glass surface, thereby increasing the measured contact angle to ∠56°, which is characteristic of a self-assembled non-protonated amine terminated monolayer on glass or a patchy methyl terminated layer on glass. See, for example, Barriet et al, “4-Mercaptophenylboronic acid SAMs on gold: comparison with SAMs derived from thiophenol, 4-mercaptophenol, and 4-mercaptobenzoic Acid”, Langmuir 23, (2007), pp. 8866-8875, and Peters et al, “Using self-assembled monolayers exposed to X-rays to control the wetting behaviour of thin films of diblock copolymers”, Langmuir 16, (2000), pp. 4625-4631.

Contact angle measurements conducted for a silicate glass and for the K⁺ exchanged silicate waveguide that were treated with oxygen plasma and immersed in the 67% NMA solution in hexane for 1 hour at room temperature showed similar results. However, the measurements that were repeated on the samples cleaned with solvent, but not exposed to oxygen plasma, did not indicate any change in the contact angle. Therefore, the conclusion was made that the oxygen plasma treatment is the key to the surface modification process.

### Ellipsometry

The thickness of the created NMA layer on the channel waveguide was measured using Uvisel 2 HORIBA Scientific ellipsometer equipped with a 190-880 nm Twin PMT detector. An incidence angle of 70° from the normal direction to the surface was employed to measure the thickness of the layer from the planar K⁺ exchanged silicate channel waveguide immersed in the 67% NMA solution in hexane. The refractive index of 1.571 at 589 nm was assumed for the film yielding a thickness of 8 nm.

### Length of the NMA Molecule

The end-to end length of the NMA molecule was calculated with Spartan 14 software package (Wavefunction, Inc.) to be 7.239 Å. Reported values for benzene-based adsorbed monolayers are no more than 9 Å (see Barriet et al (2007) cited above). Therefore, the conclusion was made that a multilayer structure was formed on the surface of the channel waveguide of the NIR spectrometer of the embodiments.

While certain features of the present application have been illustrated and described herein, many modifications, substitutions, changes, and equivalents will be apparent to those of ordinary skill in the art. It is, therefore, to be understood that the appended claims are intended to cover all such modifications and changes as fall within the true spirit of the present application.

What is claimed is:

1. A near-infrared (NIR) spectrometer for label-free molecular analysis of a sample, said NIR spectrometer is integrated in a lab-on-chip and comprises:
a) a broadband NIR source configured to generate NIR light pulses;
b) a single-mode (SM) optical fibre optically connecting the broadband NIR source with a collimating objective and designed to transmit said NIR light pulses from said NIR source to said collimating objective;
c) the collimating objective configured to collimate the NIR light pulses received from the NIR source into a narrow collimated NIR light beam, and directing said narrow collimated NIR light beam to a focusing objective;
d) the focusing objective configured to receive the narrow collimated NIR light beam from the collimating objective, to align on-axis the NIR beam and to focus said beam onto a polarisation maintaining optical fibre;
e) the polarisation maintaining (PM) optical fibre optically coupled into a channel waveguide of a polydimethylsiloxane (PDMS) chamber, optically connecting the focusing objective with the channel waveguide, and configured to transmit the focused NIR light beam from the focusing objective into the channel waveguide;
f) the PDMS chamber mounted on the silicate glass support and designed to be filled with the sample and to receive the NIR light beam from the channel waveguide;
g) the cannel waveguide of the PDMS chamber, built in a silicate glass support and configured to transmit the NIR light beam to and from the PDMS chamber;
h) a multi-mode (MM) optical fibre optically coupled into the channel waveguide of the PDMS chamber, optically connecting the channel waveguide with an optical spectrum analyser and configured to transmit the NIR light beam into the optical spectrum analyser;
i) the optical spectrum analyser configured to receive the NIR light beam, partially absorbed by the sample and transmitted from the PDMS chamber, to measure an output signal intensity of the NIR light beam versus a wavelength of said NIR light beam, and to transfer the obtained signal intensity data to a computing unit; and
j) the computing unit configured to receive the signal intensity data from the optical spectrum analyser, to perform calculations relating to mathematical analysis of the data and to display said data in a readable format or to plot said data in a form of a transmittance or absorbance spectrum of the sample.

2. The NIR spectrometer of claim 1, wherein said broadband NIR source is a high-power fibre-continuum laser.

3. The NIR spectrometer of claim 2, wherein said high-power fibre-continuum laser is configured to operate at the central wavelength of 1060 nm with spectral bandwidth ranging from 450 nm to 1750 nm.

4. The NIR spectrometer of claim 2, wherein said high-power fibre-continuum laser is configured to generate optical pulses with a duration less than 10 ps.

5. The NIR spectrometer of claim 1, wherein said SM optical fibre further comprises an optical fibre interface allowing the NIR light beam to enter and exit the optical fibre.

6. The NIR spectrometer of claim 1, wherein said PM optical fibre optically connecting the focusing objective with the channel waveguide is an 8-μϕ polarisation-maintaining optical fibre.

7. The NIR spectrometer of claim 6, wherein said PM optical fibre further comprises an optical fibre interface allowing the NIR light beam to enter and exit the optical fibre.

8. The NIR spectrometer of claim 1, wherein said MM optical fibre optically connecting the channel waveguide with the optical spectrum analyser, is a 62-μϕ or 200-μϕ multi-mode optical fibre.

9. The NIR spectrometer of claim 8, wherein said MM optical fibre further comprises an optical fibre interface allowing the NIR light beam to enter and exit the optical fibre.

10. The NIR spectrometer of claim 1, wherein said optical spectrum analyser is a wavelength-selective optical power meter that measures signal power versus wavelength, and is tunable over a specified wavelength range.

11. The NIR spectrometer of claim 10, wherein said optical spectrum analyser is configured to analyse the spectrum over the range from 600 nm to 1700 nm.

12. The NIR spectrometer of claim 1, wherein said lab-on-chip further comprises on-chip microfluidic channels.

13. The NIR spectrometer of claim 1, wherein said lab-on-chip further comprises one or more functional microfluidic device.

14. The NIR spectrometer of claim 13, wherein said functional microfluidic device is adapted to generate micro-droplets of the sample.

15. The NIR spectrometer of claim 1, wherein said functional microfluidic device is a micro-reactor allowing one or more reactions to occur within the microfluidic device.

16. In a method for label-free, rapid, portable and high-precision (i) molecular composition analysis of a sample, (ii) chemical or biological sensing, (iii) trace detection of environmentally important analytes, toxins, drugs or explosives, or (iv) chemical identification and quantification of analytes in the sample, the improvement comprises using the NIR spectrometer of claim 1.

17. The method of claim 16, wherein said method comprises a step of identification of the analyte via its unique absorption spectral signatures in a NIR spectral region.
